(19) United States
(12) Patent Application Publication
(10) Pub. No.: US 2012/0249926 A1
(43) Pub. Date: Oct. 4, 2012

(54) BACKLIGHT MODULE AND DISPLAY APPARATUS

(75) Inventors: Gege Zhou, Guangdong (CN); Yi-cheng kuo, Guangdong (CN)

(73) Assignee: Shenzhen China Star Optoelectronics Technology Co., Ltd., Shenzhen, Guangdong (CN)

(21) Appl. No.: 13/128,524

(22) PCT Filed: Apr. 19, 2011
(86) PCT No.: PCT/CN2011/073023

§ 371 Date: May 10, 2011

(30) Foreign Application Priority Data
Mar. 31, 2011 (CN) 201110082727.5

(51) Int. Cl. G02F 1/13357; F21V 7/22

(52) U.S. Cl. 349/65; 362/613

(57) ABSTRACT

The present invention provides a backlight module and a display apparatus. The backlight module comprises a back bezel and at least one light source. The back bezel has a first surface and a second surface opposite thereto, wherein the back bezel includes a plurality of convex portions formed on the second surface. The light source is disposed on the first surface of the back bezel, wherein at least a portion of the convex portions is positioned in a high-temperature region of a temperature distribution diagram of the back bezel. The present invention can use the convex portion of the back bezel to improve the heat-dissipation effect.

### FIELD OF THE INVENTION

The present invention relates to a backlight module and a display apparatus, and more particularly to a backlight module and a display apparatus capable of improving the heat dissipation efficiency thereof.

### BACKGROUND OF THE INVENTION

Liquid crystal displays (LCDs) have been widely applied in electrical products. Currently, most LCDs are backlight type LCDs that comprise a liquid crystal panel and a backlight module. According to the position of the light sources for providing LCDs with backlight, the backlight module can be classified into a side-light type or a direct-light type.

The heat generated by the LCDs which is in working status may affect the efficiency thereof, thus the heat dissipation thereof is very important. In the side-light type backlight module, the light sources, such as light emitting diodes (LEDs), are disposed at one side of a light guide plate. However, the heat of the LEDs tends to be accumulated at one side of the LCD, resulting in uneven heat dissipation, as well as deteriorating the light efficiency of the LEDs and the display quality of the LCD.

As a result, it is necessary to provide a backlight module and a display apparatus to solve existing problems in conventional technologies such as above-mentioned.

### SUMMARY OF THE INVENTION

A primary object of the present invention is to provide a backlight module, wherein the backlight module comprises: a back bezel having a first surface and a second surface opposite thereto, wherein the back bezel includes a plurality of convex portions formed on the second surface; at least one light source which is disposed on the first surface of the back bezel, wherein at least a portion of the convex portions is positioned in a high-temperature region of a temperature distribution diagram of the back bezel, and the temperature distribution diagram is predetermined before forming the convex portions on the back bezel.

A secondary object of the present invention is to provide a backlight module, wherein the backlight module comprises: a back bezel having a first surface and a second surface opposite thereto, wherein the back bezel includes a plurality of convex portions formed on the second surface; at least one light source which is disposed on the first surface of the back bezel, wherein at least a portion of the convex portions is positioned in a high-temperature region of a temperature distribution diagram of the back bezel, and the temperature distribution diagram is predetermined before forming the convex portions on the back bezel, wherein the temperature in the high-temperature region is greater than a middle temperature, and the middle temperature is an average of the highest temperature and the lowest temperature of the back bezel.

A further object of the present invention is to provide a display apparatus, wherein the display apparatus comprises a display panel and a backlight module. The backlight module comprises: a back bezel having a first surface and a second surface opposite thereto, wherein the back bezel includes a plurality of convex portions formed on the second surface; at least one light source which is disposed on the first surface of the back bezel, wherein at least a portion of the convex portions is positioned in a high-temperature region of a temperature distribution diagram of the back bezel, and the temperature distribution diagram is predetermined before forming the convex portions on the back bezel.

In one embodiment of the present invention, the convex portions are elongated convex portions.

In one embodiment of the present invention, the convex portions are scattered convex portions.

In one embodiment of the present invention, the backlight module further comprises a light guide plate disposed on the back bezel, wherein the light source is disposed at one side of the light guide plate, and the convex portions are arranged as a triangular shape at one side of the back bezel.

In one embodiment of the present invention, the backlight module further comprises a light guide plate disposed on the back bezel, wherein two light sources are disposed at a first side and a second side of the back bezel, respectively, and the convex portions are arranged as a triangular shape at the first side and the second side of the back bezel.

In one embodiment of the present invention, an area, density or quantity of an arrangement of the convex portions positioned at the first side of the back bezel is less than the area, density or quantity of another arrangement of the convex portions positioned at the second side.

In one embodiment of the present invention, the cross-sectional shape of the convex portions is an arc, a triangle or a rectangle.

In one embodiment of the present invention, the convex portions which are arranged at the middle of the back bezel are denser in comparison to the convex portions which are arranged at the two opposite sides of the back bezel.

In one embodiment of the present invention, the light sources are distributed on the first surface of the back bezel, and at least a portion of the convex portions is positioned at the center of the back bezel.

In one embodiment of the present invention, the convex portions are formed as one-piece together with the back bezel on the second surface.

In comparison to the conventional backlight module having a heat concentration problem, according to the position of the light source, the heat dissipation area in a partial region of the back bezel of the backlight module and the display apparatus of the present invention can be increased for efficiently dissipating the heat of the light source. Therefore, the heat-dissipation effect of the backlight module and the display apparatus of the present invention can be improved, thus homogenizing the temperature distribution and enhancing the display quality of the display apparatus.

The structure and the technical means adopted by the present invention to achieve the above-mentioned and other objects can be best understood by referring to the following detailed description of the preferred embodiments and the accompanying drawings:

### DESCRIPTION OF THE DRAWINGS

FIG. 1 is a schematic diagram showing a backlight module and a display panel according to a first embodiment of the present invention;

FIG. 2 is a bottom view showing a back bezel according to a first embodiment of the present invention;

FIG. 3 is a cross-sectional view showing the back bezel according to the first embodiment of the present invention;

FIG. 4 is a schematic diagram showing a backlight module according to a second embodiment of the present invention;

FIG. 5 is a three dimensional view showing a back bezel according to the second embodiment of the present invention;

FIG. 6 is a temperature distribution diagram of the backlight module according to the second embodiment of the present invention;

FIG. 7 is a bottom view showing the back bezel according to the second embodiment of the present invention;

FIG. 8 is a partially cross-sectional view showing a backlight module according to a third embodiment of the present invention;

FIG. 9 is a bottom view showing a back bezel according to a fourth embodiment of the present invention;

FIG. 10 is a cross-sectional view showing a back bezel according to a fifth embodiment of the present invention;

FIG. 11 is a cross-sectional view showing a back bezel according to a sixth embodiment of the present invention; and

FIG. 12 is a cross-sectional view showing a back bezel according to a seventh embodiment of the present invention.

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, like reference numerals indicate like components or items.

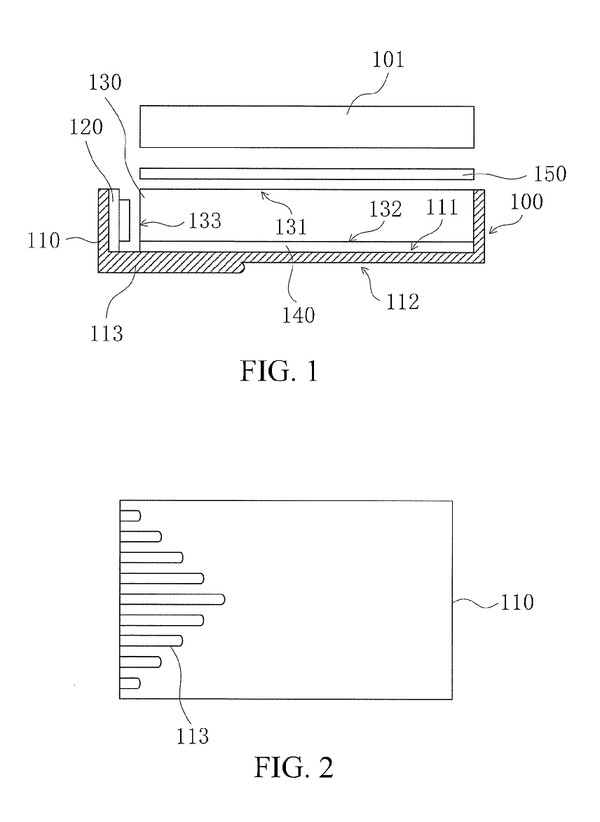

Referring to FIG. 1, FIG. 1 is a schematic diagram showing a backlight module and a display panel according to a first embodiment of the present invention. In the present embodiment, the backlight module 100 may be a side-light type backlight module and disposed opposite to a display panel 101 (such as a liquid crystal display panel), thereby forming a display apparatus (such as an LCD apparatus). The backlight module 100 comprises a back bezel 110, at least one light source 120, a light guide plate 130, a reflective layer 140 and at least one optical film 150. The back bezel 110 is configured to carry the light source 120, the light guide plate 130, the reflective layer 140 and the optical film 150. The at least one light source 120 is disposed at one side of the light guide plate 130 to emit light thereto for guiding light into the display panel 101. The reflective layer 140 may be formed between the back bezel 110 and the light guide plate 130 for reflecting the light of the light source 120. The optical film 150 is disposed above the light guide plate 130 for optical improvement.

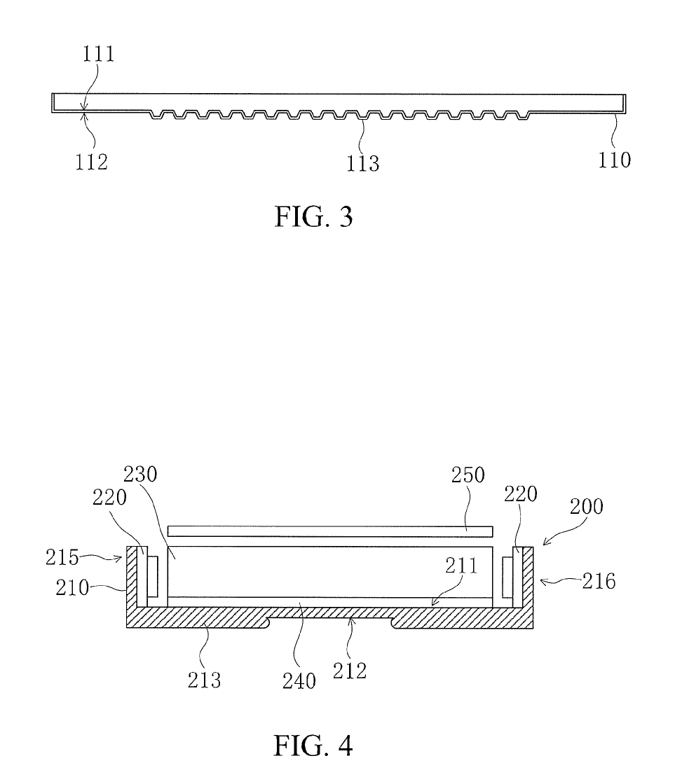

Referring to FIG. 2 and FIG. 3, FIG. 2 is a bottom view showing a back bezel according to a first embodiment of the present invention, and FIG. 3 is a cross-sectional view showing the back bezel according to the first embodiment of the present invention. The back bezel 110 of the present embodiment may be made of an opaque material, such as plastic, metal or any combination material thereof. The back bezel 110 has a first surface 111 and a second surface 112 opposite thereto, wherein the back bezel 110 includes a plurality of convex portions 113 which are formed on the second surface 112, so as to increase the heat dissipation area of the back bezel 110 for improving the heat dissipation effect. The convex portions 113 may be formed as one-piece together with the back bezel 110 for needs by extrusion molding, stamping, cutting, casting, machining, compression molding or forging. The convex portions 113 may have various cross-sectional shapes, such as an arc, a triangle, a rectangle or any other shape. In this embodiment, the convex portions 113 may be elongated convex portions (referring to FIG. 2). At least a portion of the convex portions 113 is positioned in a high-temperature region of a temperature distribution diagram of the back bezel 110. The temperature distribution diagram is predetermined before forming the convex portions 113 on the back bezel 110 for realizing the heat distribution of the back bezel 110. Normally, the temperature in the high-temperature region is substantially greater than a middle temperature. The middle temperature is an average of the highest temperature and the lowest temperature of the back bezel 110.

Referring to FIG. 1 again, the light source 120 of the present embodiment is, for example, a cold cathode fluorescent lamp (CCFL), a light emitting diodes (LED), an organic light emitting diode (OLED), an electro-luminescence (EL) device, a light bar, or any combination thereof.

In one embodiment, the light source 120 may be, for example, a light bar which includes a circuit broad and a lighting element (such as an LED chip). The circuit broad may be a printed circuit board (PCB) or a flexible printed circuit (FPC). The lighting element is disposed on the circuit broad.

Referring to FIG. 1 again, the light guide plate 130 of the present embodiment may be made by the method of injection molding, and the material thereof may be photo-curable resin, polymethylmethacrylate (PMMA) or polycarbonate (PC) for guiding the light of light source 120 toward the liquid crystal display panel 101. The light guide plate 130 includes a light output surface 131, a light reflection surface 132 and a light input side surface 133. The light output surface 131 is formed on one side of the light guide plate 130 and faces to the liquid crystal display panel 101. The light output surface 131 may include a cloudy surface or a plurality of scattering patterns to uniform light outputted from the light guide plate 130 for preventing the situation of mura. In another embodiment, the light output surface 131 may include a plurality of protruding structures (not shown) to modify the direction of light, thereby condensing light and enhancing the brightness thereof, wherein the protruding structures may be prism-shaped structures or semicircle-shaped structures. The light reflection surface 132 is formed opposite to the light output surface 131 for reflecting light thereto. In the present embodiment, the light reflection surface 132 of the light guide plate 130 is parallel to the light output surface 131. The light reflection surface 132 may have a plurality of light guiding structures (not shown) formed thereon to guide light to the light output surface 131. The light guiding structures of the light reflection surface 132 may be a continuous V-shaped structure, i.e. V-cut structures, a cloudy surface or scattering patterns, thereby guiding the light of the light source 120 to be outputted from the light output surface 131. The light input side surface 133 is formed on one side or two opposite sides of the light guide plate 130 and corresponding to the light source 120 for allowing the light emitted by the light source 120 to be inputted in the light guide plate 130. The light input side surface 133 may have V-shaped structures (V-cut structures), S-shaped structures or a rough surface structure (not shown) to raise light incidence efficiency and light coupling efficiency. In the embodiment, the light input side surface 133 may be a plane surface vertical to the light reflection surface 132.

Referring to FIG. 1 again, the reflective layer 140 (or a reflective sheet) of the present embodiment is preferably formed on the surface of the light guide plate 130, such as the light reflection surface 132, and merely exposes the light input side surface 133 for allowing light to be inputted and the light output surface 131 allowing light to be outputted. The reflective layer 140 may be made of a highly reflective material, such as any combination of alloys Ag, Al, Au, Cr, Cu, In, Ir, Ni, Pt, Re, Rh, Sn, Ta, W, Mn, and a white reflective paint with etiolation-resistant and heat-resistant properties or any combination thereof for reflecting light.

Referring to FIG. 1 again, the optical film 150 of the present embodiment may be a diffuser, a prism sheet, a turning prism sheet, a brightness enhancement film (BEF), a dual brightness enhancement film (DBEF), a diffused reflective polarizer film (DRPF) or any combination thereof disposed above the light guide plate 130 for improving the light outputted from the light guide plate 130.

Referring to FIG. 1 and FIG. 2 again, the formed positions of convex portions 113 of the back bezel 110 are determined according to the position of the light source 120, i.e. at least a portion of the convex portions 113 is positioned below or near the light source 120 for facilitating the heat dissipation of the light source 120 and improving the heat concentration problem. In this embodiment, the light source 120 may be merely disposed at one side of the light guide plate 130, i.e. one side of the back bezel 110. At this time, the convex portions 113 may be formed on the rear surface of the back bezel 110 (the second surface 112) and arranged near the light source 120 for facilitating the heat dissipation of the light source 120 and even-out the temperature distribution of the back bezel 110.

Referring to FIG. 2 and FIG. 3 again, a shape, density, or quantity of an arrangement of the convex portions 113 of the back bezel 110 can be determined according to the temperature distribution of the backlight module 100. After the position of the light source 120 at the back bezel 110 is determined and the light source 120 has worked for a predetermined time, the backlight module 100 can have a specific heat distribution (temperature distribution diagram). For example, the backlight module, which has the light source disposed at one side of the back bezel, may have a substantially triangular heat distribution. At this time, in the present embodiment, the convex portions 113 can be arranged as a triangular shape corresponding to the heat concentration of the back bezel 110 (the high-temperature region of the temperature distribution diagram) to increase the heat dissipation area of a middle region of the back bezel 110, thereby improving the heat dissipation of the back bezel 110 and even-out the temperature distribution thereof. However, according to the heat distribution of the backlight module 100, the convex portions 113 may be arranged as other shapes but not limited to the above-mentioned description.

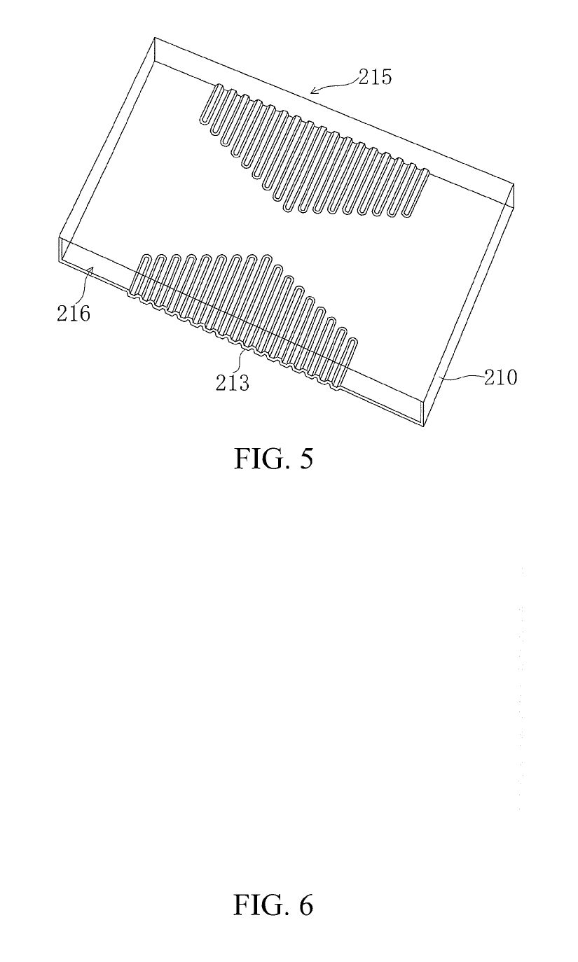

Referring to FIG. 3 again, a cross-sectional view showing the back bezel according to the first embodiment of the present invention is illustrated. In this embodiment, portions of the back bezel 110 bend toward the second surface 112 (referring to FIG. 4 and FIG. 5), and thus the convex portions 113 are formed on the second surface 112 as one-piece together with the back bezel 110.

When the light source 120 of the backlight module 100 provides the backlight for the display panel 101, due to the convex portions 113 formed on the rear surface of the back bezel 110 and near the light source 120, the heat-dissipation effect which is formed near the light source 120 can be improved to prevent the heat concentration of the light source 120 and to enhance a luminous efficiency thereof. Therefore, the back bezel 110 of the backlight module 100 can improve the heat-dissipation effect and homogenize the temperature distribution thereof to enhance the display quality of the display apparatus.

Referring to FIG. 4 and FIG. 5, FIG. 4 is a schematic diagram showing a backlight module according to a second embodiment of the present invention, and FIG. 5 is a three dimensional view showing a back bezel according to the second embodiment of the present invention. Only the difference between the embodiment and the first embodiment will be described hereinafter, and thus the similar portions there-between will be not stated in detail herein. The backlight module 200 of the second embodiment comprises a back bezel 210, two light sources 220, a light guide plate 230, a reflective layer 240 and at least one optical film 250. In comparison to the first embodiment, the light sources 220 may be light bars which are disposed at a first side 215 and a second side 216 opposite thereto. The light guide plate 230 is disposed between the light sources 220. The back bezel 210 has a first surface 211 and a second surface 212 opposite thereto, wherein the back bezel 210 includes a plurality of convex portions 213 which are formed on the second surface 212 and near the first side 215 and the second side 216, so as to increase the heat dissipation area near the first side 215 and the second side 216 of the back bezel 110 for facilitating the heat dissipation of the light sources 220.

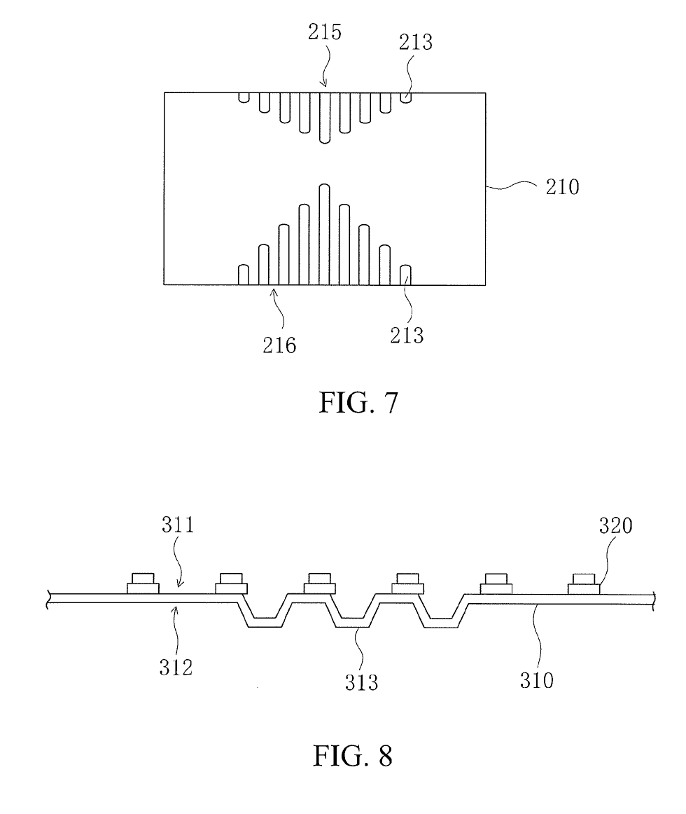

Referring to FIG. 6 and FIG. 7, FIG. 6 is a temperature distribution diagram of the backlight module according to the second embodiment of the present invention, and FIG. 7 is a bottom view showing a back bezel according to the second embodiment of the present invention. A position, shape, density or quantity of an arrangement of the convex portions 213 of the back bezel 210 can be determined according to the temperature distribution diagram of the back bezel 210. The temperature distribution diagram is predetermined before forming the convex portions 213 on the back bezel 210. The temperature distribution diagram can be obtained by using a thermal detector and is used to show the temperature distribution of the back bezel 210 before forming the convex portions 213. For example, when the display apparatus is vertical and turned on, the first side 215 and the second side 216 are positioned at the top and bottom of the display apparatus, respectively. At this time, from the temperature distribution diagram of the backlight module 200 (the back bezel 210), the high-temperature regions (referring to FIG. 6, the temperature in the high-temperature regions is substantially greater than 32) of the back bezel 210 are formed near the first side 215 and the second side 216, respectively, and the high-temperature regions are substantially in triangular shape. Furthermore, since the heat dissipation effect of the top of the vertical display apparatus is better, the area, density or quantity of an arrangement of the convex portions 213 positioned at the first side 215 (corresponding to the top of the display apparatus) of the back bezel 210 can be less than the area, density or quantity of another arrangement of the convex portions 213 positioned at the second side 216 (corresponding to the bottom of the display apparatus). Accordingly, the convex portions 213 can be arranged according to the predetermined temperature distribution diagram for homogenizing the heat dissipation of the backlight module 200 and enhancing the display quality of the display apparatus.

Referring to FIG. 8, a partially cross-sectional view showing a backlight module according to a third embodiment of the present invention is illustrated. The backlight module of the third embodiment may be a direct-light type backlight module. At this time, the light sources 320 may be a plurality of light bars which are distributed on the first surface 311, and the convex portions 313 of the back bezel 310 are formed on the second surface 312 and positioned between the light sources 320. At least a portion of the convex portions 313 is preferably positioned at the center of the back bezel 310 to prevent the heat concentration of the light sources 320 and to homogenize the temperature distribution of the backlight module. Therefore, the convex portions 313 of the back bezel 310 can improve the heat-dissipation effect to enhance the display quality of the display apparatus.

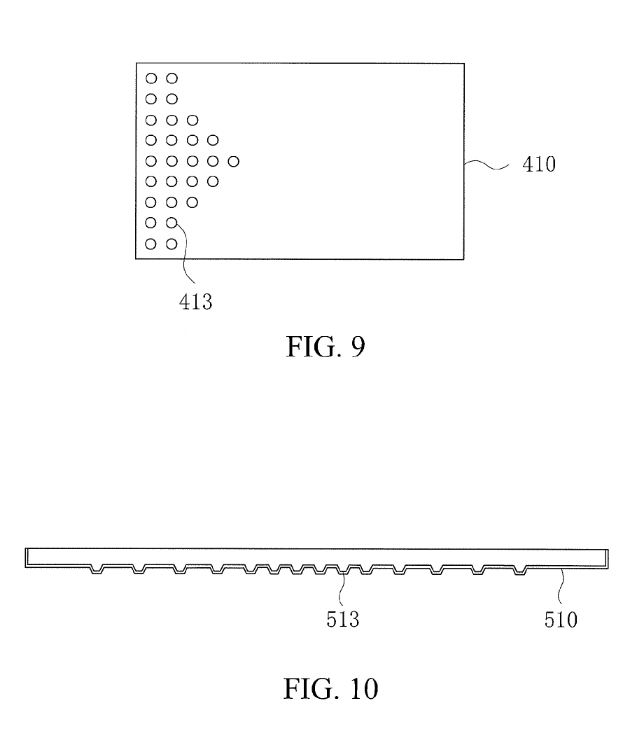

Referring to FIG. 9, a bottom view showing a back bezel according to a fourth embodiment of the present invention is illustrated. The convex portions 413 of the back bezel 410 may be scattered convex portions which are arranged as a triangular shape corresponding to the heat concentration of the back bezel for increasing the heat-dissipation area, thus improving the heat-dissipation effect and homogenizing the temperature distribution of the back bezel 410.

Referring to FIG. 10, a cross-sectional view showing the back bezel according to a fifth embodiment of the present invention is illustrated. The convex portions 513 which are arranged at the middle of the back bezel 510 are denser in comparison to the convex portions 513 which are arranged at the two opposite sides of the back bezel 510, i.e., there are more convex portions 513 being arranged at the middle of the back bezel 510, and alternatively, the pitch is less between the convex portions 513 being arranged at the middle of the back bezel 510. Accordingly, the heat dissipation area at the middle of the back bezel 510 can be enlarged to improve the heat concentration problem.

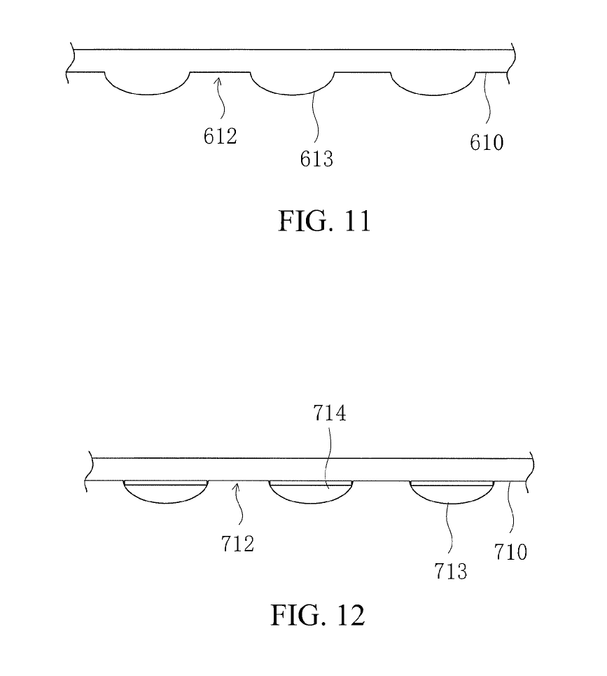

Referring to FIG. 11, a cross-sectional view showing the back bezel according to a sixth embodiment of the present invention is illustrated. In the sixth embodiment, portions of the back bezel 610 protrude from the second surface 612, thereby forming the convex portions 613 as one-piece together with back bezel 610.

Referring to FIG. 12, a cross-sectional view showing the back bezel according to a seventh embodiment of the present invention is illustrated. In the seventh embodiment, the convex portions 713 are bonded to the second surface 712 of the back bezel 710 by a thermal conductive adhesive 714.

As described above, in the backlight module and the display apparatus of the present invention, the heat dissipation area can be enlarged by the convex portions of the back bezel. Furthermore, the arrangement of the convex portions is determined according to the position of the light source for efficiently dissipating the heat thereof and improving the heat concentration problem thereof. Therefore, the heat-dissipation effect of the backlight module and the display apparatus of the present invention can be improved, thus homogenizing the temperature distribution and enhancing the display quality of the display apparatus.

The present invention has been described with a preferred embodiment thereof and it is understood that many changes and modifications to the described embodiment can be carried out without departing from the scope and the spirit of the invention that is intended to be limited only by the appended claims.

1. A backlight module, comprising:
a back bezel having a first surface and a second surface opposite thereto, wherein the back bezel includes a plurality of convex portions formed on the second surface; and
at least one light source disposed on the first surface of the back bezel, wherein at least a portion of the convex portions is positioned in a high-temperature region of a temperature distribution diagram of the back bezel, and the temperature distribution diagram is predetermined before forming the convex portions on the back bezel, wherein the temperature in the high-temperature region is greater than a middle temperature, and the middle temperature is an average of the highest temperature and the lowest temperature of the back bezel.

2. A backlight module, comprising:
a back bezel having a first surface and a second surface opposite thereto, wherein the back bezel includes a plurality of convex portions formed on the second surface; and
at least one light source disposed on the first surface of the back bezel, wherein at least a portion of the convex portions is positioned in a high-temperature region of a temperature distribution diagram of the back bezel, and the temperature distribution diagram is predetermined before forming the convex portions on the back bezel.

3. The backlight module according to claim 2, wherein the convex portions are elongated convex portions.

4. The backlight module according to claim 2, wherein the convex portions are scattered convex portions.

5. The backlight module according to claim 2, further comprising a light guide plate disposed on the back bezel, wherein the light source is disposed at one side of the light guide plate, and the convex portions are arranged as a triangular shape at one side of the back bezel.

6. The backlight module according to claim 2, further comprising a light guide plate disposed on the back bezel, wherein two light sources are disposed at a first side and a second side of the back bezel, respectively, and the convex portions are arranged as a triangular shape at the first side and the second side of the back bezel.

7. The backlight module according to claim 6, wherein an area, density or quantity of an arrangement of the convex portions positioned at the first side of the back bezel is less than an area, density or quantity of another arrangement of the convex portions positioned at the second side.

8. The backlight module according to claim 2, wherein the cross-sectional shape of the convex portions is an arc, a triangle or a rectangle.

9. The backlight module according to claim 2, wherein the convex portions which are arranged at the middle of the back bezel are denser in comparison to the convex portions which are arranged at the two opposite sides of the back bezel.

10. The backlight module according to claim 2, wherein the light sources are distributed on the first surface of the back bezel, and at least a portion of the convex portions is positioned at the center of the back bezel.

11. A display apparatus, comprising:
a display panel; and
a backlight module comprising:
a back bezel having a first surface and a second surface opposite thereto, wherein the back bezel includes a plurality of convex portions formed on the second surface; and
at least one light source disposed on the first surface of the back bezel, wherein at least a portion of the convex portions is positioned in a high-temperature region of a temperature distribution diagram of the back bezel, and the temperature distribution diagram is predetermined before forming the convex portions on the back bezel.

12. The display apparatus according to claim 11, wherein the convex portions are elongated convex portions.

13. The display apparatus according to claim 11, wherein the convex portions are scattered convex portions.

14. The display apparatus according to claim 11, further comprising a light guide plate disposed on the back bezel, wherein the light source is disposed at one side of the light guide plate, and the convex portions are arranged as a triangular shape at one side of the back bezel.

15. The display apparatus according to claim 11, further comprising a light guide plate disposed on the back bezel, wherein two light sources are disposed at a first side and a second side of the back bezel, respectively, and the convex portions are arranged as a triangular shape at the first side and the second side of the back bezel.

16. The display apparatus e according to claim 15, wherein an area, density or quantity of an arrangement of the convex portions positioned at the first side of the back bezel is less than an area, density or quantity of another arrangement of the convex portions positioned at the second side.

17. The display apparatus according to claim 11, wherein a cross-sectional shape of the convex portions is an arc, a triangle or a rectangle.

18. The display apparatus according to claim 11, wherein the convex portions which are arranged at the middle of the back bezel are denser in comparison to the convex portions which are arranged at the two opposite sides of the back bezel.

19. The display apparatus according to claim 11, wherein the light sources are distributed on the first surface of the back bezel, and at least a portion of the convex portions is positioned at the center of the back bezel.

20. The display apparatus according to claim 11, wherein the convex portions are formed on the second surface as one-piece together with the back bezel.
